(19) United States
(12) Patent Application Publication
(10) Pub. No.: US 2010/0245196 A1
(43) Pub. Date: Sep. 30, 2010

(54) ANTENNA POSITIONING SYSTEM

(76) Inventor: EYAL MIRON, Hod-Hasharon (IL)

Correspondence Address: DANIEL J SWIRSKY, 55 REUVEN ST., BEIT SHEMESH, 99544, IL

(21) Appl. No.: 12/547,607

(22) Filed: Aug. 26, 2009

Related U.S. Application Data
(60) Provisional application No. 61/163,339, filed on Mar. 25, 2009.
(60) Provisional application No. 61/177,285, filed on May 12, 2009.

(51) Int. Cl. H01Q 3/00; F16M 11/20; F16M 11/00

(52) U.S. Cl. 343/763; 248/676; 248/637

(57) ABSTRACT

A pointing apparatus for pointing an object at a target along a pointing axis, including a joint enabling at least yaw and pitch of the object with respect to a base, at least one actuator operative to effect the yaw and pitch of the object by effecting at least one of rotating the object about a first axis perpendicular to the pointing axis to form a first rotation angle, and rotating the object about a second axis perpendicular to both the pointing axis and the first axis, effecting a second rotation angle, where, while effecting at least one of a yaw angle and a pitch angle of the object, the object is concurrently rotated about the pointing axis at a roll angle corresponding to the yaw angle.

### CROSS-REFERENCE TO RELATED APPLICATIONS

This application claims priority from U.S. Provisional Patent Application No. 61/163,339, filed Mar. 25, 2009, and U.S. Provisional Patent Application No. 61/177,285, filed May 12, 2009, the disclosures of which are incorporated herein by reference in their entirety.

### FIELD AND BACKGROUND OF THE INVENTION

The present invention relates to positioning systems and, more particularly, but not exclusively to satellite antenna positioning systems. In this respect, the term “positioning” refers to directing, aiming, or orienting an object, or stabilizing the direction, aim, or orientation of an object.

Typically, the positioning system aims the positioned object at a target, which may be a second object. Typically, however not necessarily, the positioned object or the target or both are moving. In this respect, the positioning system may also function as a tracking system for tracking a moving target or a mobile tracking system for a fixed target.

Particularly, the present invention relates to a positioning (or stabilizing or tracking) system where the positioned object is coupled by a cable to a fixed object, which is usually associated with the base of the positioning system. The term cable refers to a wire, a cord, a conductor, an electric conductor, an optical conductor, a fiber optic, a pipe, and a tube, a flexible connection and an articulated connection.

The present invention relates to positioning system of an antenna, and further to a positioning system of a satellite antenna. However, the positioning system may also be useful for a camera, a laser, etc. The cable in this respect refers to any means for transporting power (such as electrical power or mechanical power), materials, information, data (such as in the form of electrical, acoustic or optical signals), and/or content between a fixed object and the positioned object.

The cable, or rather the fixed side of the cable, limits the maneuverability of the positioning system and/or the positioned object. Typically, the maneuvering of the positioned object is limited to avoid wear and/or tear of the cable. Managing the limit posed by the cable complicates the design of the positioning system, and further complicates the control of the positioning, or maneuvering, or the positioned object. Typically, the positioning system cannot rotate the positioned object in one direction without having to stop and counter rotate the positioned object to rewind the cable. This requirement also limits the design of the cable, with respect to flexibility, thickness, length, etc.

Common solutions to the limitation on the rotation due to the twisting of the cable use a rotary joint and/or a slip ring. These are rotatable electrical contactors that enable continuous rotation while preserving electrical contact. Both solutions are use friction between two electric conductors to maintain electrical contact, and friction is a major cause of wear and failure. Practically, both the rotary joint and the slip ring require frequent maintenance and experience contact deterioration. Such contact deterioration is especially problematic with high frequency transmissions such as with radar and satellite communication.

The following US patent applications are believed to represent the most relevant prior art: U.S. Pat. Nos. 3,987,452, 3,999,184, 4,035,805, 4,100,472, 4,920,350, 5,359,337, 5,389,940, 5,517,205, 5,945,961, 6,188,300, 6,531,990, 6,567,040, and 7,109,937.

There is thus a widely recognized need for, and it would be highly advantageous to have, a positioning system devoid of the above limitations.

### SUMMARY OF THE INVENTION

According to one aspect of the present invention there is provided a pointing apparatus for pointing an object at a target along a pointing axis, the pointing apparatus including: a joint for coupling the object to a base, and for enabling rotation of the object with respect to the base, at least one actuator operative to effect the rotation by effecting at least one of: rotating the object about a first axis perpendicular to the pointing axis, effecting a first rotation angle, and rotating the object about a second axis perpendicular to the first axis, effecting a second rotation angle where, while effecting at least one of the first rotation angle and the second rotation angle, the object is concurrently rotated about the pointing axis at a third angle, and where the third angle corresponds to at least one of the first rotation angle, the second rotation angle, and a combination of the first and second rotation angles.

According to another aspect of the present invention there is provided a pointing apparatus for pointing an object at a target along a pointing axis where the at least one actuator is operative to concurrently effect rotating the object at a yaw angle and counter-rotating the object a roll angle equal to the yaw angle.

According to yet another aspect of the present invention there is provided a pointing apparatus for pointing an object at a target along a pointing axis where the roll angle R is equal to the object's yaw angle Y modulo 360 minus 360
(i.e. R=Y mod(360)−360).

According to still another aspect of the present invention there is provided a pointing apparatus for pointing an object at a target along a pointing axis where the joint is at least one of: two axels, spaced apart where the axles are orthogonal to each other and to the pointing axis, a ball joint, and a universal joint.

Also, according to another aspect of the present invention there is provided a pointing apparatus for pointing an object at a target along a pointing axis where an actuator can be any of a rotary actuator, a linear actuator, a transmission device such as a gear, a bearing, etc., a motor, a stepper motor and a servo motor.

Additionally, according to another aspect of the present invention there is provided a pointing apparatus for pointing an object at a target along a pointing axis where the actuator includes: a first actuator for rotating the object about the first axis, and a second actuator for rotating the object about the second axis.

Further, according to another aspect of the present invention there is provided a pointing apparatus for pointing an object at a target along a pointing axis, additionally including: a third actuator for rotating the object about the pointing axis.

Still further according to another aspect of the present invention there is provided a pointing apparatus for pointing an object at a target along a pointing axis where the object is symmetrical with respect to the pointing axis.

Yet further according to another aspect of the present invention there is provided a pointing apparatus for pointing an object at a target along a pointing axis, where the target is moving with respect to the object.

Even further according to another aspect of the present invention there is provided a pointing apparatus for pointing an object at a target along a pointing axis where the object is moving with respect to the target.

According to yet another aspect of the present invention there is provided a pointing apparatus for pointing an object at a target along a pointing axis where the target is a satellite and the object is a satellite antenna.

According to still another aspect of the present invention there is provided a pointing apparatus for pointing an object at a target along a pointing axis where the object is any of: a radio antenna, a radar antenna, a satellite antenna, a dish antenna, an antenna with a parabolic reflector, a center-feed antenna, an off-center parabolic antenna, a Cassegrain antenna, a flat antenna, a planar antenna, a patch antenna, and a phased array antenna.

Also, according to another aspect of the present invention there is provided a pointing apparatus for pointing an object at a target along a pointing axis where the object is an antenna, where the antenna is operative for communication, and where the communication includes any of: radiating electromagnetic wave along the second axis, and receiving electromagnetic wave approaching the antenna along the second axis.

Additionally, according to another aspect of the present invention there is provided a pointing apparatus for pointing an object at a target along a pointing axis, additionally including: a polarizing radiation transducer operative for any of: radiating electromagnetic wave along the second axis, and receiving electromagnetic wave approaching the antenna along the second axis, where the electromagnetic wave is polarized to form electromagnetic wave polarization, and a polarizing controller operative to control the electromagnetic wave polarization, where the controller controls the electromagnetic wave polarization to compensate for the rotation of the object about the second axis.

Further according to another aspect of the present invention there is provided a pointing apparatus for pointing an object at a target along a pointing axis where the pointing apparatus is an antenna positioning system.

Yet further according to another aspect of the present invention there is provided a pointing apparatus for pointing an object at a target along a pointing axis where the antenna positioning system is mounted on a movable platform.

Still further according to another aspect of the present invention there is provided a pointing apparatus for pointing an object at a target along a pointing axis where the movable platform is at least one of a vehicle, an airframe, and a vessel.

Even further according to another aspect of the present invention there is provided a pointing apparatus for pointing an object at a target along a pointing axis, additionally including: an arm connecting the pointing apparatus to a base, and a motion stabilizer mounted between the arm and the base and operative to maintain orientation of the pointing apparatus with respect to the base when the platform performs at least one of yaw, pitch and roll.

According to yet another aspect of the present invention there is provided a pointing apparatus for pointing an object at a target along a pointing axis where the object is coupled to a second object by a flexible cable, and where maneuvering the object with respect to the second object effects rotation of the cable with respect to itself, and where the rotation of the cable does not exceed a limit when the rotation of the object with respect to the second object exceeds the limit.

According to still another aspect of the present invention there is provided a pointing apparatus for pointing an object at a target along a pointing axis where the rotation of the cable includes at least one of bending the cable, turning the cable, and twisting the cable.

Also, according to another aspect of the present invention there is provided a pointing apparatus for pointing an object at a target along a pointing axis where the limit is at least one of 180 degrees and 360 degrees.

Additionally according to another aspect of the present invention there is provided a pointing apparatus for pointing an object at a target along a pointing axis, where the cable is at least one of: a wire, a cord, a cable, a conductor, an electric conductor, an optical conductor, a fiber optic, a pipe, and a tube.

According to another aspect of the present invention there is provided a method for pointing an object at a target, the method including: yawing the object at a yaw angle to point an axis of the object at a point associated with the target, rolling the object about the axis at a roll angle corresponding to the yaw angle.

According to still another aspect of the present invention there is provided a method for pointing an object at a moving target, the object mounted on a pointing apparatus, the pointing apparatus operative to pitch, roll and yaw an axis of the object with respect to a base where the axis points at a point associated with the moving target, the method including: changing roll angle according to yaw angle.

Further according to still another aspect of the present invention there is provided a method for pointing an object at a target along a pointing axis associated with the target where the pointing axis is defined by an angle θ₁ measured from the zenith and a yaw angle θ₂, where the object is mounted on a pointing apparatus, where the pointing apparatus contains a first arm connected to a base via a maneuverable first joint where the first arm is operative to rotate at an angle α in a vertical first plane about the first joint and a second arm connected to the first arm via a maneuverable second joint where the second arm is operative to rotate at an angle β in a second plane defined by the first arm and perpendicular to the plane and where the method includes the step of calculating the α and the β angles from the θ₁ and the θ₂ angles according to the equations:

$$β = arcsin ( cos {θ}_{2} sin {θ}_{1} ) and α = - arcsin ( \frac{sin {θ}_{1} sin {θ}_{2}}{cos β} ) .$$

Unless otherwise defined, all technical and scientific terms used herein have the same meaning as commonly understood by one of ordinary skill in the art to which this invention belongs. The materials, methods, and examples provided herein are illustrative only and not intended to be limiting. Except to the extend necessary or inherent in the processes themselves, no particular order to steps or stages of methods and processes described in this disclosure, including the figures, is intended or implied. In many cases the order of process steps may vary without changing the purpose or effect of the methods described.

Implementation of the method and system of the present invention involves performing or completing certain selected tasks or steps manually, automatically, or any combination thereof. Moreover, according to actual instrumentation and equipment of embodiments of the method and system of the present invention, several selected steps could be implemented by hardware or by software on any operating system of any firmware or any combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A, 1B and 1C are three views of a simplified illustration of a positioning system;

FIGS. 2A, 2B and 2C are three simplified illustrations of the positioning system in three positions (orientations);

FIG. 3 is a simplified illustration of a satellite antenna positioning system 1 mounted on a mobile platform;

FIGS. 4A and 4B are simplified illustrations of the satellite antenna positioning system 40 in two orientations;

FIGS. 5A, 5B, 5C, 5D, and 5E are simplified illustrations of five types of a positioning system 2 and a satellite antenna.

FIG. 6 is a simplified graphs of changing yaw angle of the positioned object of FIG. 5D;

FIG. 7 simplified graphs of changing roll angle of the positioned object of FIG. 5D;

FIG. 8 simplified graphs of changing polarization of the positioned object of FIG. 5D;

FIG. 9A is a simplified illustration of a dual-arm positioning system;

FIG. 9B is a simplified illustration of the dual-arm positioning system of FIG. 9A in an XYZ axis system;

FIG. 10A is a simplified illustrations of a coverage surface of a torus sector;

FIG. 10B is a simplified illustrations of a coverage surface of a diffeomorfic dome sector; and

FIG. 10C is a simplified illustrations of a coverage surface of a dome coverage of the positioned object of FIGS. 9A and 9B.

### DETAILED DESCRIPTION OF THE INVENTION

The principles and operation of a positioning system and method according to the present invention may be better understood with reference to the drawings and accompanying description.

In this document, the term “positioning” refers to pointing, directing, aiming, or orienting an object, or stabilizing the direction, aim, or orientation of an object.

Typically, the positioning system aims the positioned object at a target, which may be a second object or a virtual point in space. Typically, the positioned object or the target or both are moving. In this respect, the positioning system may also function as a tracking system for tracking a moving target.

The positioning system and positioning method is also termed herein pointing system or pointing method, stabilizing system or stabilizing method, tracking system or tracking method, etc.

The positioning system maneuvers an object to point, direct, aim or orient the object at the target. The object is also termed herein pointed object or positioned object. Particularly, the object is an antenna, a similar radiating device, or a device for receiving radiation.

It is appreciated that when pointing, directing, aiming or orienting the object the positioning system rotates the object horizontally, about a vertical axis, also termed yaw or azimuth, and/or rotates the object vertically, about a horizontal axis, also termed pitch or elevation. It is appreciated that yaw and pitch need not be associated with the Earth's gravity field and/or horizon.

Particularly, the present invention relates to a positioned object that is coupled by a cable to a fixed object, which is usually associated with the base of the positioning system. The term cable refers to a wire, a cord, a conductor, an electric conductor, an optical conductor, a fiber optic, a pipe, and a tube, a flexible connection and an articulated connection.

The present invention relates to positioning system of an antenna, and further to a positioning system of a satellite antenna. However, the positioning system may also be useful for a camera, a laser beam, etc. The cable in this respect refers to any means for transporting power (such as electrical power or mechanical power), materials, information, data (such as in the form of electrical, acoustic or optical signals), and/or content between a fixed object and the positioned object.

The cable, or rather the fixed side of the cable, limits the maneuverability of the positioning system and/or the positioned object. Typically, the maneuvering of the positioned object is limited to avoid wear and/or tear of the cable. Managing the limit posed by the cable complicates the design of the positioning system, and further complicates the control of the positioning, or maneuvering, or the positioned object. Typically, the positioning system cannot rotate the positioned object in one direction without having to stop and counter rotate the positioned object to rewind the cable.

It is the objective of the present invention to provide a positioning system where the rotation of the cable does not limit the maneuverability of the positioned object. Alternatively, the objective of the present invention to limit the rotation of the cable without limiting the maneuverability of the positioned object. Alternatively, the objective of the present invention to avoid wear and tear of the cable without limiting the maneuverability of the positioned object, and, optionally, enabling the use of a relatively short cable.

In this document, the rotation of the cable refers to bending, turning, twisting and wrapping of the cable.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

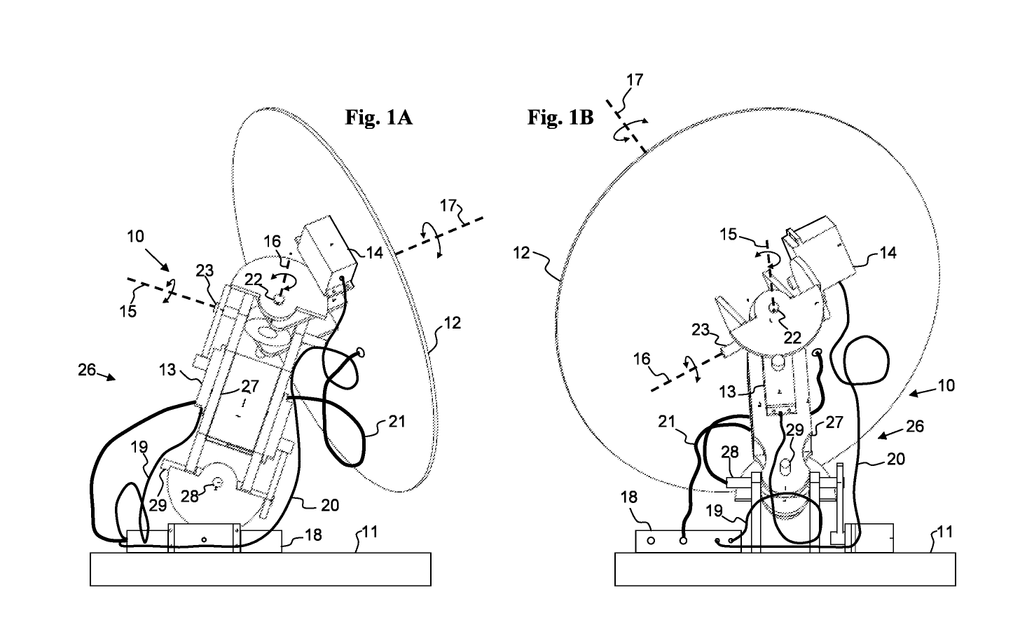

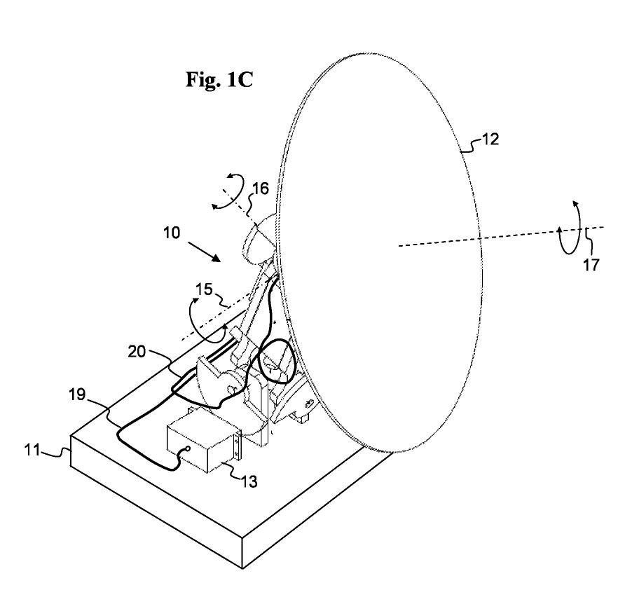

Reference is now made to FIGS. 1A, 1B and 1C, which are three views of a simplified illustration of a positioning system 10 according to an embodiment of the present invention.

As seen in FIGS. 1A, 1B and 1C, the positioning system 10 is preferably coupled to a base 11, and to a positioned object 12, which is an antenna shown from its rear side. The positioning system 10 is preferably maneuvered by two actuators 13 and 14, rotating the positioned object 12 (or pointed object) about two axes 15 and 16, respectively. The axes 15 and 16 are preferably perpendicular (orthogonal) to each other and to a pointing axis 17 of the pointed object 12. In this example, where the pointed object 12 is an antenna, the pointing axis 17 is preferably the axis of maximum gain of the antenna, which is typically directed at a receiver or a transmitter for the transmission or reception of electromagnetic signals.

The actuators 13 and 14 are preferably coupled to a controller 18, which controls the operation of the actuators 13 and 14, preferably by electric conductors 19 and 20 respectively, conducting electric power for the operation of the actuators 13 and 14. Preferably, the antenna is connected by an electric cable 21 to an RF circuitry, typically embedded in the controller 18.

The objective of the present invention is that the controller 18 controls the actuators 13 and 14 to direct the pointing axis 17 of the pointed object 12 at any suitable direction, without excessively twisting the cable 21 (and/or any other cable or wire such as electric conductors 19 and/or 20). A further objective of the present invention is to enable continuous maneuvering of the pointed object 12 while eliminating the need to stop the rotation and counter rotate the pointed object 12 to rewrap the cable 21 (and/or any other cable such as wire 20).

It is appreciated that the pointed object 12 can be an antenna, a camera, a laser beam, etc. It is also appreciated that the antenna can be any of: a radio antenna, a radar antenna, a satellite antenna, a dish antenna, an antenna with a parabolic reflector, a center-feed antenna, an off-center parabolic antenna, a Cassegrain antenna, a flat antenna, a planar antenna, a patch antenna, and a phased array antenna.

It is appreciated that the antenna is operative for radiating electromagnetic wave along the pointing axis 17 and/or for receiving electromagnetic wave approaching the antenna along the pointing axis 17.

It is appreciated that the cable 21 (as well as electric conductors 19 and/or 20) can be a wire, a cord, a cable, a conductor, an electric conductor, an optical conductor, a fiber optic, a pipe, and a tube according to the application requirements.

It is appreciated that the positioning system 10 enables directing the pointing axis 17 of the pointed object 12 at any suitable direction.

As seen in FIGS. 1A, 1B and 1C, the positioning system 10 is preferably is preferably capable of pointing the positioned object 12 at a target, where the pointing is performed along the pointing axis 17 directed at the target. The pointing operation is performed by maneuvering a joint coupling, and thus maneuvering the object 12 to the base 11, enabling the rotation of the object with respect to the base 11. At least one actuator (13, 14) is operative to effect the rotation of the joint by rotating the object about a first axis (16) perpendicular to the pointing axis 17, thus effecting a first rotation angle, and/or rotating the object about a second axis (15) perpendicular to the first axis (16), thus effecting a second rotation angle. Therefore, while effecting the first rotation angle and/or the second rotation angle, the object 12 is concurrently rotated about the pointing axis 17 at a third, roll, angle. This third angle preferably corresponds to the first rotation angle, the second rotation angle, and/or a combination of the first and second rotation angles.

The actuators 13 and 14 preferably rotate the object 12 at a yaw angle and concurrently counter-rotate the object a roll angle equal to the yaw angle. The roll angle R is preferably equal to the yaw angle Y modulo 360 minus 360, preferably according to Eq. 1.

R=Y mod(360)−360

As seen in FIGS. 1A and 1B, the positioning system 10 includes two axles 22 and 23. Preferably, axle 22, which coincides with axis 16, is orthogonal to the pointing axis 17, and axle 23, which coincides with axis 15, is orthogonal to axle 22. The two actuators 14 and 13 are provided to maneuver the object 12 and to orient the pointing axis 17 at the target or any other required direction. It is appreciated that two axels (and two actuators) are enough to orient the pointed object 12 at any direction or any combination of yaw and pitch angles (i.e. any combination of azimuth and elevation angles). It is also appreciated that the two-axis positioning system 10 of FIGS. 1A and 1B, preferably including the two axles 24 and 25 (i.e. the two-axles positioning system 10) performs automatic rolling of the object 12. That is, concurrently with the orienting of the object, the object is rolled about the pointing axis 17 at the opposite direction to the yaw (azimuth) angle, as described above.

It is appreciated that while the positioning system 10 of FIGS. 1A and 1B, preferably rolls the object 12 continuously and opposite to the yaw angle, continuous rolling is not mandatory. That is, a positioning system according to the present invention may roll the object 12 at discreet rotations. For example, the positioning system may roll the object instantaneously at 5 degrees for every 5 degrees of yaw. Preferably, the positioning system may roll the object instantaneously at 45 degrees for every 45 degrees of yaw, or at 90 degrees for every 90 degrees of yaw, as will be further discussed below with reference to polarization. It is appreciated that the orientation and the rolling of the object can be performed with a positioning system including three axes and three actuators, preferably, a first axle and actuator for yaw, a second axel and actuator for pitch, and a third axle and actuator of roll.

As seen in FIGS. 1A and 1B, the positioning system 10 is coupled to the base 11 with an additional stirring system 26. The stirring system 26 preferably contains an arm 27 and a joint for maneuvering the arm. The joint preferably contains two orthogonal axes (28 and 29) and two actuators to maneuver the positioning system 10 with respect to the base. The stirring system 26 is preferably used for coarse maneuvering, while the positioning system 10 is used for fine maneuvering, of the pointed object 12. The use of system 26 is not mandatory for the present invention and is illustrated here as optional addition to the positioning system 10. However, the use of the stirring system 26 is advantageous as a motion stabilizer for example to maintain orientation of the pointing apparatus with respect to the base when the platform carrying the base yaws, pitches and/or rolls.

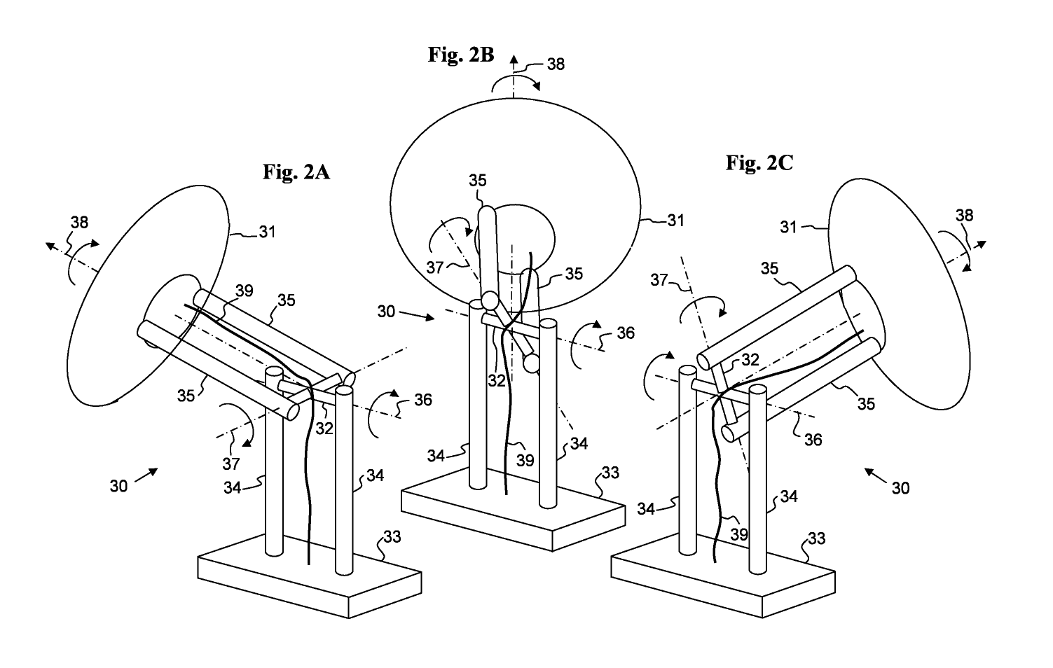

Reference is now made to FIGS. 2A, 2B and 2C, which are three simplified illustrations of a positioning system 30 in three positions (orientations), according to an embodiment of the present invention.

The positioning system 30 is viewed in FIGS. 2A, 2B and 2C in three positions, or pointing orientations, of the positioned (pointed) object 31. In FIGS. 2A, 2B and 2C the object 31 (and at least a part of the positioning system 30) is horizontally rotated (yaw), between FIG. 2A to FIG. 2B to FIG. 2C, at about 45 degrees at each step.

The positioning system 30 includes a joint 32, coupling an object 31 to a base 33 via arms 34 and 35. The positioning system 30 also contains actuators for maneuvering the object 31 about the joint 32 and with respect to the base 33. For simplicity, the actuators are not shown in FIGS. 2A, 2B and 2C.

The joint 32 of FIGS. 2A, 2B and 2C is a Caradn joint, also known as a universal joint, a U joint, a Hardy-Spicer joint, or Hooke's joint. Alternatively, the joint 32 can be a ball joint, or a gimbal, or a spaced joint such as drawn in FIGS. 1A, 1B and 1C.

It is appreciated that joint 32 of FIGS. 2A, 2B and 2C contains two axles operative to maneuver the object 31 about two orthogonal axes 36 and 37. It is appreciated that the alternative ball joint and gimbal are also enabling the maneuvering of the pointed object about two orthogonal axes. As well as the spaced joint of FIGS. 1A, 1B and 1C rotating the pointed object 12 about orthogonal axes 15 and 16.

The positioning system 30 (as well as the positioning system 10) also rotates the pointed object 31 about a third axis 38. Axis 38 is preferably orthogonal to one of axes 36 and 37. Preferably, axis 38 is orthogonal to axis 37, which is not the axis coupled to the base 33.

A cable 39 is connected preferably between the object 31 and a fixed object, preferably associated with the base 33. For simplicity of FIGS. 2A, 2B and 2C, the cable 39 is connected directly to the base 33.

As seen in FIGS. 2A, 2B and 2C, the object 31 is rotated horizontally (yaw), by rotating the joint 32 about the two axes 36 and 37. Following the order of FIGS. 2A, 2B and 2C it is seen that the object 31 is rotated is rotated clockwise, and that subsequently and concurrently the object 31 is rotated (rolled) counterclockwise. Preferably, the roll angle is equal and opposite to the yaw angle. Therefore, the cable is not twisted more than 180 degrees even if the object 31 is yawed over 180 degrees, over 360 degrees, or any other yaw angle. Using the positioning system 30 (as well as positioning system 10), object 31 can be yawed freely in any direction without wrapping the cable 39 more than 180 degrees, thus significantly limiting its wear and tear. Furthermore, there is no need to stop the rotation in any point in order to wrap the cable back. Object 31 can be yawed indefinitely in any direction without wrapping the cable 39 more than 180 degrees. Moreover, object 31 can be maneuvered in any combination of yaw and pitch angles, freely and indefinitely, without wrapping the cable 39 more than 360 degrees. Practically, for a hemispheric positioning system, the cable will not be twisted over 180 degrees.

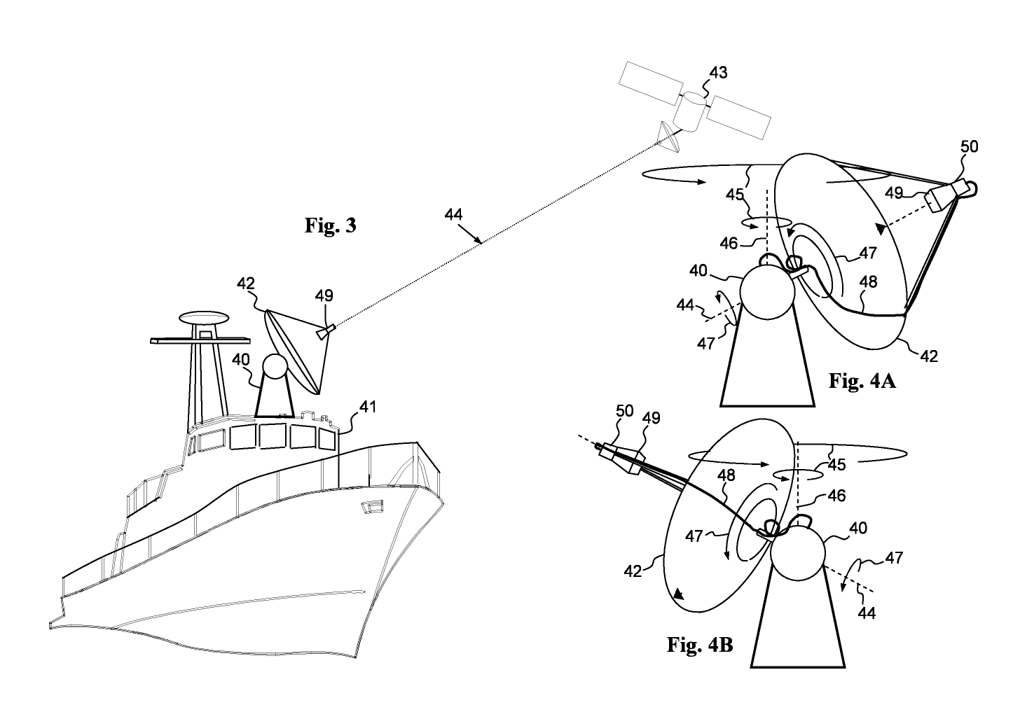

Reference is now made to FIG. 3, which is a simplified illustration of a satellite antenna positioning system 40 mounted on a mobile platform 41, and to FIGS. 4A and 4B, which are simplified illustrations of the satellite antenna positioning system 40 in two orientations, according to an embodiment of the present invention.

As seen in FIG. 3, the satellite antenna positioning system 40 is mounted on the mobile platform 41, pointing the satellite antenna 42 at a satellite 43 along a pointing axis 44. As the mobile platform 41 changes its orientation with respect to the satellite, such as by yaw, pitch and roll of the mobile platform 41, the satellite antenna positioning system 40 changes the orientation of the satellite antenna 42 with respect to the mobile platform 41, to compensate for the motions of the mobile platform 41 and to point the satellite antenna 42 towards the satellite 43. Consequently, the mobile platform 41 yaws, pitches and rolls the satellite antenna 42 with respect to the mobile platform 41 so that the pointing axis 44 is maintained at the direction of at the satellite 43. Hence, the pointing axis 44 is also the roll axis of the satellite antenna 42.

As seen in FIGS. 4A and 4B, the roll angle is changed in the same but opposite value of the yaw angle. In FIGS. 4A and 4B the yaw angle 45 is changed clockwise by 90 degrees about the yaw axis 46, while the roll angle 47 is changed counterclockwise by 90 degrees about the pointing axis 44.

It is appreciated that the mobile platform 41 is a vessel. However, alternatively, the mobile platform 41 can be an airplane or a car.

It is appreciated that the satellite 43 is a geostationary satellite. However, alternatively, the positioning system 40 can point the antenna at a fast orbiting satellite, an airplane, a missile, or any other platform.

It is appreciated that the antenna can be any of: a radio antenna, a radar antenna, a satellite antenna, a dish antenna, an antenna with a parabolic reflector, a center-feed antenna, an off-center parabolic antenna, a Cassegrain antenna, a flat antenna, a planar antenna, a patch antenna, and a phased array antenna.

As seen in FIGS. 4A and 4B a cable 48 is connected between the satellite antenna 42 and a fixed part of the positioning system 40 such as a base. It is appreciated that with the positioning system 40, as the antenna 42 is pitched, yawed and rolled accordingly (that is at a roll angle equal and opposite to the yaw angle), the twisting of the cable 48 is limited. Preferably, the twisting angle is limited to the pitch angle, and/or to 180 degrees with respect to any yaw angle, even yaw angles larger than 360 degrees.

As seen in FIGS. 3, 4A and 4B, the satellite antenna 42 is a dish antenna with a feed horn 49 mounted along the pointing axis 44. As the positioning system 40 rolls the satellite antenna 42 about the pointing axis 44, the feed horn 49 is also rotated about the pointing axis 44 and with respect to the satellite 43, thus changing the orientation of the polarization axes. If required, such as with polarization that is not circular polarization, there is a need to compensate for this rotation, preferably using a polarization controller 50.

For example, the polarization controller 50 can control maintain the polarization of the satellite antenna 42 by counter-rotting the feed horn 49. This method of mechanical rotation of the horn is known in the art, for example, using ARP-1 polarization rotator from Antenna Research Associates, Inc., of 12201 Indian Creek Court, Beltsville, Md. 20705, USA.

Alternatively, the polarization controller 50 can control maintain the polarization of the satellite antenna 42 by using an orthomode transducer (OMT) and a pair of rotatable quarter-wave plates, constructed in circular waveguide, as known in the art.

Another alternative to compensate for the rolling of the polarization axes is to use phased array antenna.

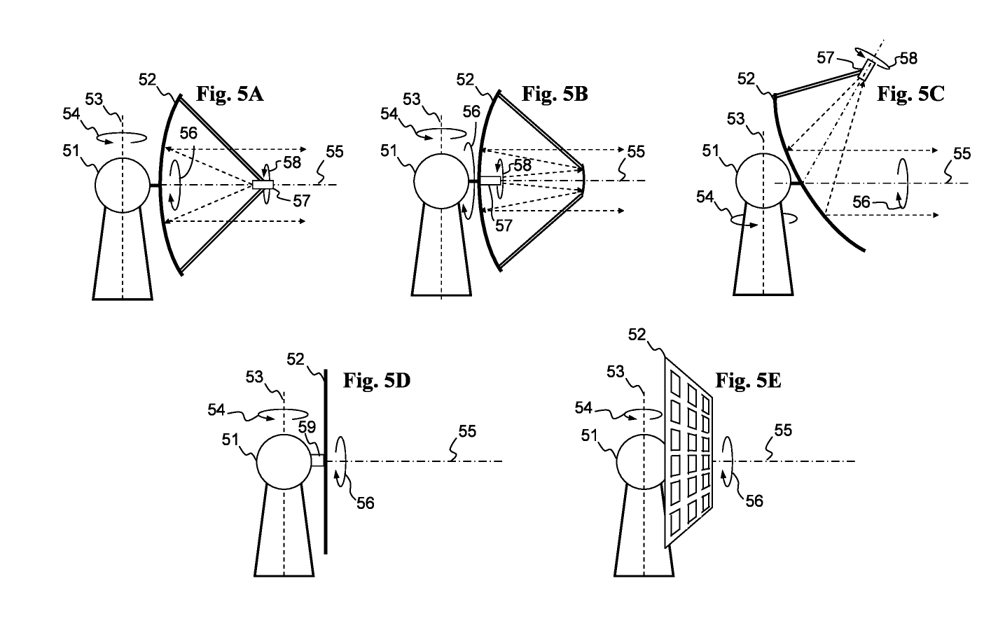

Reference is now made to FIGS. 5A, 5B, 5C, 5D, and 5E, which are simplified illustrations of five types of a positioning system 51 and a satellite antenna 52, according to an embodiment of the present invention.

In FIG. 5A the positioning system 51 controls the orientation of satellite antenna 52 that is a regular dish antenna, preferably using a parabolic reflector, and a center feed-horn (center fed antenna).

In FIG. 5B the positioning system 51 controls the orientation of satellite antenna 52 that is a Cassegrain antenna.

In FIG. 5C the positioning system 51 controls the orientation of satellite antenna 52 that is an off-center parabolic antenna

In FIG. 5D the positioning system 51 controls the orientation of satellite antenna 52 that is a flat antenna or a planar antenna or a patch antenna

In FIG. 5E the positioning system 51 controls the orientation of satellite antenna 52 that is a phased array antenna.

FIGS. 5A, 5B, 5C, 5D, and 5E also show the respective yaw axis 53 and rotation angle 54 and the pointing or roll axis 55 and the roll rotation angle 56 for the five configurations of the positioning system 51 and satellite antenna 52.

FIGS. 5A, 5B, and 5C also show polarization compensation mechanism to rotate the feed horn 57 at an angle 58 that preferably compensates for the roll of the antenna 52. Preferably, the polarization compensation rotation angle is equal and opposite (counter-rotating) to antenna roll angle 56.

The positioning systems 51 of FIGS. 5A, 5B, and 5C include a polarizing radiation transducer operative to radiate electromagnetic wave along the pointing axis and/or to receive electromagnetic wave approaching along the pointing axis. Preferably, the electromagnetic wave is polarized to form electromagnetic wave polarization. Preferably, the polarizing radiation transducer is part of the pointed object, which is the antenna 52. The positioning systems 51 also preferably include a polarizing controller to control the electromagnetic wave polarization, preferably to compensate for the rotation of the object about the pointing axis.

The pointed (or positioned) objects of FIGS. 5A and 5B, namely the antennas 52, are preferably symmetrical. The pointing axis 55 preferably coincides with the symmetry axis and the antenna 52 is thus rolled about its symmetry axis, so that the radiation pattern does not change when the antenna is rolled.

The pointed (or positioned) object of FIG. 5C, namely the antenna 52, is asymmetrical and rolled about the pointing axis 55, which is not the symmetry axis of the antenna 52.

The positioning system 51 of FIG. 5D additionally includes a rolling mechanism 59 for rolling the positioned object 52. This is an example of a positioning system according to the present invention that additionally preserves the polarization characteristics of the antenna 52. For example, assuming that the antenna should preserve vertical polarization, the positioning system of FIG. 5D does not continuously roll the antenna as the yaw angle changes. Instead, the positioning system performs instantaneous rotation of the antenna at discreet horizontal (yaw, azimuth) positions.

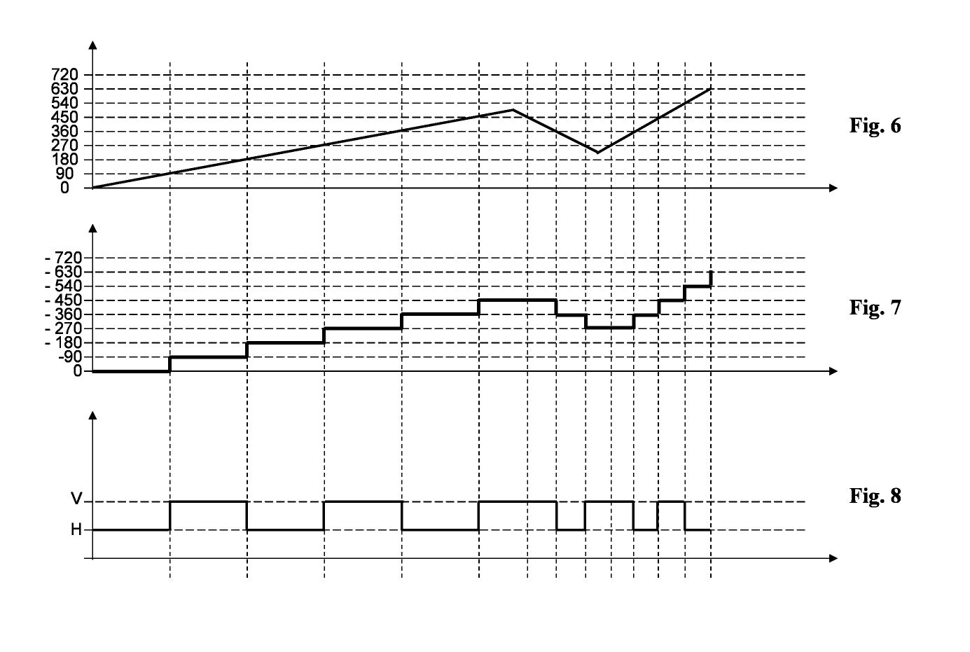

Reference is now made to FIG. 6, FIG. 7, and FIG. 8, which are, respectively, simplified graphs of changing yaw angle, roll angle and polarization of the positioned object of FIG. 5D, according to an embodiment of the present invention.

It is appreciated that FIGS. 6, 7 and 8 provide an example of the relations between the changing of the yaw angle, the roll angle and the polarization of an antenna, such as the positioned object 52 maneuvered by the positioning system 51 of FIG. 5D. It is appreciated that the example presented with respect to FIGS. 6, 7 and 8 can also be applied to other types of positioning systems and antenna.

As seen in FIG. 6, the yaw angle of the positioned object is changed from zero degrees to over 450 degrees (more than one complete rotation, then back to less than 270 degrees, and then to 630 degrees. The change of the yaw angle in FIG. 6 is linear only by way of example and can behave differently, for example, not linearly.

As seen in FIG. 7, the change of the roll angle follows the change of the yaw angle in discreet changes every 90 degrees and in the opposite direction. By way of example, the yaw angle changes clockwise and the roll angle change counter clockwise.

It is appreciated that the roll angle can follow the yaw angle continuously, or in discreet changes of 90 degrees as presented in FIG. 7, or in discreet changes of other values. The discreet changes of 90 degrees are useful for preserving polarization.

As seen in FIG. 8, the polarization fields of the antenna are changed in accordance with the change of the roll angle to preserve the polarization of the antenna. It is appreciated that this is not necessary if the roll angle is changed every 180 degrees.

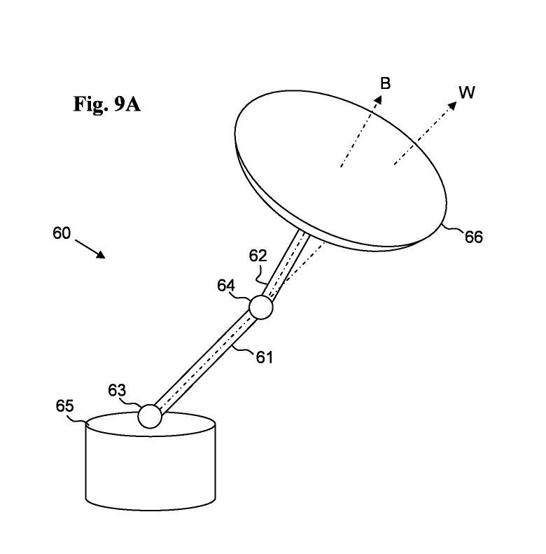

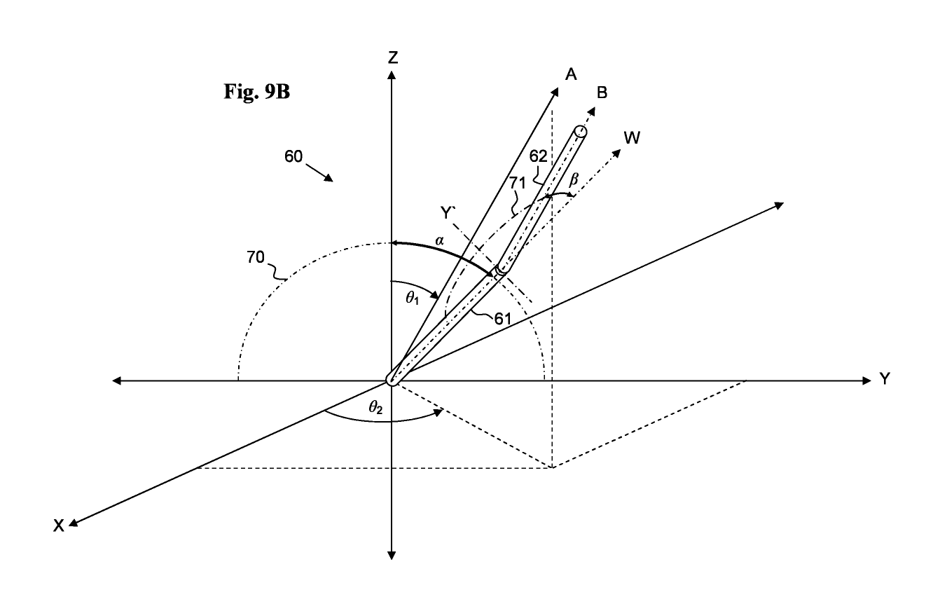

Reference is now made to FIGS. 9A and 9B, which are two versions of a simplified illustration of a dual-arm positioning system 60 according to an embodiment of the present invention.

The dual-arm positioning system 60 preferably includes a first arm 61 and a second arm 62, a first joint 63 and a second joint 64 connecting the second arm 62 to the first arm 61, and a first and a second manipulating elements (not shown). The first arm 61 connects via the first joint 63 to a base 65, preferably mobile. A positioned object 66 connects to the second arm 62. The first manipulating element maneuvers the first arm 61 about the first joint 63 with respect to the base 65 and the second manipulating element maneuvers the second arm 62 about the joint 64 with respect to the first arm 61.

As seen in FIG. 9A the positioned object 66 is an antenna, preferably a satellite antenna. The satellite antenna can be any of the antennas shown in FIGS. 5A-5E or any other type of antenna. It is appreciated that the positioned object 66 can be any other type of instrument as described above.

As seen in FIG. 9A, the first arm 61 is oriented at direction W and the second arm 62 is oriented at direction B, which is the orientation of the positioned object 66.

FIG. 9B shows the dual-arm positioning system 60 in an axis system. For visual simplicity, FIG. 9B does not show the base 67, the positioned object 66, and the joints 63 and 64.

As seen in FIG. 9B, the first arm 61 can be preferably rotated about the first joint (not shown in FIG. 9B) at an angle α in the YZ plane of the XYZ axis system. As seen in FIG. 9B the second arm 62 can be preferably rotated at an angle β about the second joint (not shown in FIG. 9B) in the XW plane, where W is an axis oriented along (or in the direction of) the first arm 61 as shown in 9A. As seen in FIG. 9B, the combination of the α and β angles orient the second arm 62 (as well as the positioned object 66 of FIG. 9A) at the direction B.

It is appreciated that, when orienting the positioned object 66 at a target, the orientation of the target with respect to the base 68 is known. The orientation of the target with respect to the base 69 is preferably given as pitch (elevation) angle θ₁ and yaw (azimuth) angle θ₂. The following discussion describes the calculation of the angles α and β from the angles θ₁ and θ₂.

As seen in FIG. 9B, A is the required direction as defined in the XYZ axis system by pitch angle θ₁ and by yaw angle θ₂. Preferably, pitch angle θ₁ is measured from the Z axis, which preferably points to the zenith. Preferably, yaw angle θ₂ is measured from the X axis in the ZY plane.

The unit vector uₛ is defined by Eq. 1:

uₛ={cos θ₂ sin θ₁,sin θ₁ sin θ₂, cos θ₁}

B is the combined direction of first arm 61 and second arm 62, and is compatible with direction A. The first arm 61 is tilted in direction W as defined by angle α in plane YZ, and the second arm 62 is tilted in direction B as defined by angle β in plane WX.

The rotation of the first arm 61 is defined by matrix Q₁ according to Eq. 2:

$${Q}_{1} = ( \begin{matrix}1 & 0 & 0 \\ 0 & cos α & - sin α \\ 0 & sin α & cos α\end{matrix} ) \qquad Eq . 2$$

If we define the orientation of the first arm 61 along the Z axis (so that α=0) the direction of the unit vector of the first arm 61 after the rotation will be the multiplication of the matrix Q₁ by the vector \hat{Z}={0,0,1}.

The rotation of the second arm 62 about axis y is defined by matrix Q₂ according to Eq. 3:

$${Q}_{2} = ( \begin{matrix}cos β & 0 & sin β \\ 0 & 1 & 0 \\ - sin β & 0 & cos β\end{matrix} ) \qquad Eq . 3$$

If we define the orientation of the second arm 62 along the Z axis (so that β=0) the direction of the unit vector of the second arm 62 after the rotation will be the multiplication of the matrix Q₂ by the vector \hat{Z}={0,0,1}.

In the general case, the overall orientation Q is given by the multiplication of the matrices Q₁ and Q₂ according to Eq. 4:

$$Q = {Q}_{1} \cdot {Q}_{2} = ( \begin{matrix}cos β & 0 & sin β \\ sin α sin β & cos α & - cos β sin α \\ - cos α sin β & sin α & cos αcos β\end{matrix} ) \qquad Eq . 4$$

The direction of the unit vector uₐ of the second arm 62 after the combined rotation will be the multiplication of the matrix Q by the vector \hat{Z}={0,0,1} as described by Eq. 5.

uₐ=Q·\hat{Z}={sin β,−cos β sin α,cos α cos β}

Comparing Eqs. 1 and 5 gives Eqs. 6A and 6B, which define the transformation of angles θ₁ and θ₂ to angles α and β.

$$\begin{matrix}β = arcsin ( cos {θ}_{2} sin {θ}_{1} ) & Eq . 6 A \\ α = - arcsin ( \frac{sin {θ}_{1} sin {θ}_{2}}{cos β} ) & Eq . 6 B\end{matrix}$$

Therefore, given the direction A to which the positioned object should be directed by angles θ₁ and θ₂ the orientation (rotation angles α and β) of the first arm 61 and the second arm 62 are given by Eqs. 6B and 6A.

Regarding the transformation continuity, the Jacobian J is defined by Eq. 7:

$$J ≡ ( \begin{matrix}\frac{\partial α}{\partial {θ}_{1}} & \frac{\partial α}{\partial {θ}_{2}} \\ \frac{\partial β}{\partial {θ}_{1}} & \frac{\partial β}{\partial {θ}_{2}}\end{matrix} ) \qquad Eq . 7$$

The Jacobian J describes the local transformation in the vicinity of θ₁ and θ₂ so that the change in angles d θ₁ and d θ₂ defines the change in angles dα and dβ according to Eq. 8:

$$\{ \begin{matrix}d α \\ d β\end{matrix} \} = J \{ \begin{matrix}d {θ}_{1} \\ d {θ}_{2}\end{matrix} \} \qquad Eq . 8$$

Therefore, the transformation is continuous if the determinant of J (det J) as described by Eq. 9 is bounded for all θ₁ and θ₂ in the required range of θ₁ and dθ₂.

$$det J = \sqrt{\frac{{cos}^{2} {θ}_{1}}{1 - {cos}^{2} {θ}_{2 } {sin}^{2} {θ}_{1}} tan {θ}_{1}} \qquad Eq . 9$$

The required range of θ₁ and θ₂ as defined by Eqs. 10A and 10B:

0°≦θ₁<90°

0°≦θ₂≦360°

Since θ₁ is limited to less than 90° there is no division by zero and therefore the expression for det J is bounded and the transformation is continuous. The mechanical movements of the first and second arms 61 and 62 are therefore smooth.

The reciprocity of the transformation determines the possibility that different required orientations (angles θ₁ and θ₂) can have the same solution (angles α and β). Since det J is different from zero for all angles θ₁ and θ₂ except when θ₁ equals zero there is a different solution for each orientation.

As seen in FIG. 9A, the positioned (or pointed) object 66 is preferably mounted on the pointing apparatus 60, which preferably includes the first arm 61 connected to the base 65 via the maneuverable first joint 63 and the second arm 62 connected to the first arm via the maneuverable second joint 64. The positioned object 66 is preferably mounted on the second arm 62. It is appreciated that the second arm 62 can be very short, as seen in FIGS. 1A and 1B. The first arm 61 is preferably operative to rotate at an angle α in a vertical first plane 70 about the first joint 63 and the second arm 62 is preferably operative to rotate at an angle β in a second plane 71 defined by the first arm 61 and perpendicular to the first plane 70. The positioned object 66 is preferably pointed (or directed) at a target along a pointing axis A associated with the target. The pointing axis A is defined by an angle θ₁ measured from the zenith, and a yaw angle θ₂. The method for pointing the positioned object 66 at the target along the pointing axis A preferably includes calculating the α and the β angles from the θ₁ and the θ₂ angles according to Eqs. 6A and 6B described above.

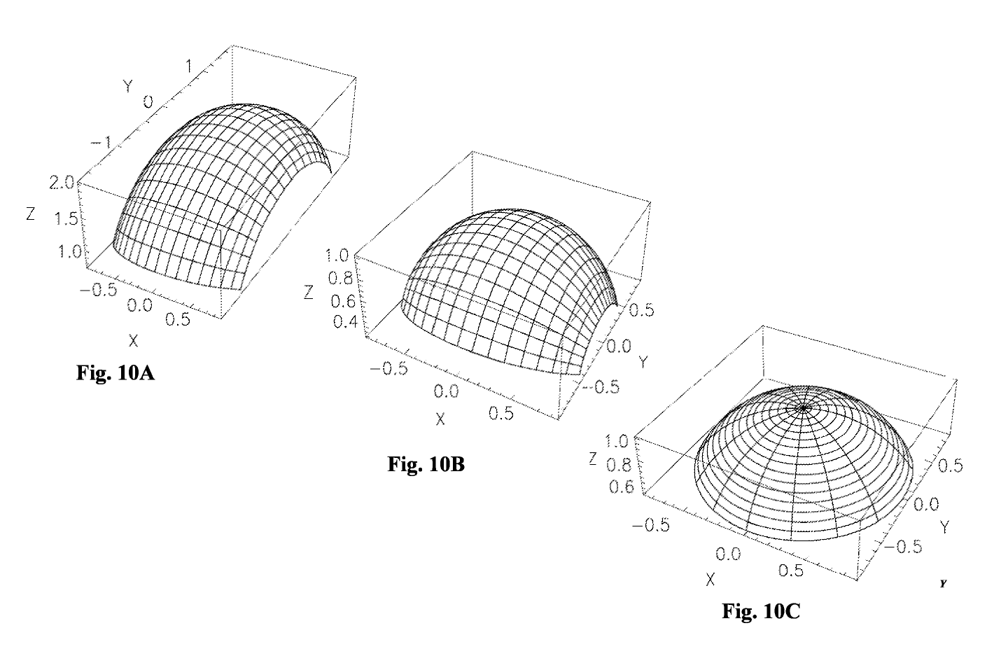

Reference is now made to FIGS. 10A, 10B, and 10C, which are simplified illustrations of the coverage surface of a torus sector, a diffeomorfic dome sector, and a dome coverage of the positioned object according to an embodiment of the present invention.

In terms of Differential geometry, the group of combinations of the orientations of the first and second arms 61 and 62 defines a sector of a torus as seen in FIG. 10A. This torus sector is diffeomorphic to a dome sector as seen in FIG. 10B. The dome seen in FIG. 10C defines the group of the possible required orientations of the positioned object 66 of FIG. 9A. The dome sector of FIG. 10B covers the dome of FIG. 10C, which proves that every orientation A of the positioned object 66 can be translated into a combination of positions of the first and second arms 61 and 62 as shown by FIGS. 10B and 10A.

Practically and preferably, the positioning system according to the present invention contains two stages:
A lower stage, closer to the base, for coarse maneuvering; and
An upper stage, close to the positioned object, for fine maneuvering.

Any and/or both of the stages can include the structure as described with reference to FIGS. 9A and 9B. For any and/or for both of the stages the angle θ₁ is preferably bounded at 0°≦θ₁≦60°. It is appreciated that the maneuvering at θ₁ angles close to 90° is relatively sensitive and difficult and therefore it is advantageous the divide the maneuvering of the positioned object into two stages as described above, where preferably at the upper stage, or at both stages, the angle θ₁ is bounded at 0°≦θ₁≦60°.

It is expected that during the life of this patent many relevant positioning devices and systems will be developed and the scope of the terms herein, particularly of the terms “actuator” and “joint”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A pointing apparatus for pointing an object at a target along a pointing axis, said pointing apparatus comprising:
a joint for coupling said object to a base, and for enabling rotation of said object with respect to said base;
at least one actuator operative to effect said rotation by effecting at least one of:
rotating said object about a first axis perpendicular to said pointing axis, effecting a first rotation angle, and
rotating said object about a second axis perpendicular to said first axis, effecting a second rotation angle;
wherein, while effecting at least one of said first rotation angle and said second rotation angle, said object is concurrently rotated about said pointing axis at a third angle, and
wherein said third angle corresponds to at least one of said first rotation angle, said second rotation angle, and a combination of said first and second rotation angles.

2. A pointing apparatus according to claim 1 wherein said at least one actuator is operative to concurrently effect rotating said object at a yaw angle and counter-rotating said object a roll angle equal to said yaw angle.

3. A pointing apparatus according to claim 1 wherein said roll angle R is equal to said object's yaw angle Y modulo 360 minus 360.

4. A pointing apparatus according to claim 1 wherein said joint is at least one of:
two axles, spaced apart, wherein said axles are orthogonal to each other and to said pointing axis;
a gimabl;
a ball joint; and
a universal joint.

5. A pointing apparatus according to claim 1 wherein at least one actuator is at least one of a rotary actuator, a linear actuator and a transmission device (gear, bearing), a motor, a stepper motor and a servo motor.

6. A pointing apparatus according to claim 1 wherein said at least one actuator comprises:
a first actuator for rotating said object about said first axis, and
a second actuator for rotating said object about said second axis.

7. A pointing apparatus according to claim 6 additionally comprising:
a third actuator for rotating said object about said pointing axis.

8. A pointing apparatus according to claim 1 wherein said object is symmetrical with respect to said pointing axis.

9. A pointing apparatus according to claim 1 wherein said target is moving with respect to said object.

10. A pointing apparatus according to claim 1 wherein said object is moving with respect to said target.

11. A pointing apparatus according to claim 1 wherein said target is a satellite and said object is a satellite antenna.

12. A pointing apparatus according to claim 1 wherein said object is at least one of:
a radio antenna;
a camera;
a laser beam;
a light source;
a detector; and
a display.

13. A pointing apparatus according to claim 12 wherein said radio antenna is at least one of:
a radar antenna;
a satellite antenna;
a dish antenna;
an antenna with a parabolic reflector;
a center-feed antenna;
an off-center parabolic antenna;
a Cassegrain antenna;
a flat antenna;
a planar antenna;
a patch antenna; and
a phased array antenna;

14. A pointing apparatus according to claim 13 wherein said antenna is operative for communication, and wherein said communication comprises at least one of:
radiating electromagnetic wave along said pointing axis; and
receiving electromagnetic wave approaching said antenna along said pointing axis.

15. A pointing apparatus according to claim 13 additionally comprising:
a polarizing radiation transducer operative for at least one of:
radiating electromagnetic wave along said pointing axis; and
receiving electromagnetic wave approaching said antenna along said pointing axis;
wherein said electromagnetic wave is polarized to form electromagnetic wave polarization; and
a polarizing controller operative to control said electromagnetic wave polarization;
wherein said controller controls said electromagnetic wave polarization to compensate for said rotation of said object about said second axis.

16. A pointing apparatus according to claim 13 additionally comprising:
a third actuator operative to roll said antenna about said pointing axis to maintain polarization orientation.

17. A pointing apparatus according to claim 12 wherein said pointing apparatus is an antenna positioning system.

18. A pointing apparatus according to claim 17 wherein said antenna positioning system is mounted on a movable platform.

19. A pointing apparatus according to claim 18 wherein said movable platform is at least one of a vehicle, an airframe, and a vessel.

20. A pointing apparatus according to claim 1 additionally comprising:
an arm connecting said pointing apparatus to a base; and
a motion stabilizer mounted between said arm and said base and operative to maintain orientation of said pointing apparatus with respect to said base when said platform performs at least one of yaw, pitch and roll.

21. A pointing apparatus according to claim 1 wherein said object is coupled to a second object by a flexible cable, and wherein maneuvering said object with respect to said second object effects rotation of said cable with respect to itself, and wherein said rotation of said cable does not exceed a limit when said rotation of said object with respect to said second object exceeds said limit.

22. A pointing apparatus according to claim 21 wherein said rotation of said cable comprises at least one of bending said cable, turning said cable, and twisting said cable.

23. A pointing apparatus according to claim 21 wherein said limit is at least one of 180 degrees and 360 degrees.

24. A pointing apparatus according to claim 21 wherein said cable is at least one of: a wire, a cord, a cable, a conductor, an electric conductor, an optical conductor, a fiber optic, a pipe, and a tube.

25. A method for pointing an object at a target, said method comprising:
yawing said object at a yaw angle to point an axis of said object at a point associated with said target;
rolling said object about said axis at a roll angle corresponding to said yaw angle.

26. A method for pointing an object at a target, said object mounted on a pointing apparatus, said pointing apparatus operative to pitch, roll and yaw an axis of said object with respect to a base wherein said axis points at a point associated with said target, said method comprising:
changing roll angle according to yaw angle.

27. A method for pointing an object at a target along a pointing axis associated with said target wherein said pointing axis is defined by an angle θ₁ measured from the zenith and a yaw angle θ₂; said object mounted on a pointing apparatus, said pointing apparatus comprising:
a first arm connected to a base via a maneuverable first joint wherein said first arm is operative to rotate at an angle α in a vertical first plane about said first joint;
a second arm connected to said first arm via a maneuverable second joint wherein said second arm is operative to rotate at an angle β in a second plane defined by said first arm and perpendicular to said first plane and;
wherein said method comprises calculating said α and β angles from said θ₁ and θ₂ angles according to:
$$β = arcsin ( cos {θ}_{2} sin {θ}_{1} ) ; and α = - arcsin ( \frac{sin {θ}_{1} sin {θ}_{2}}{cos β} ) .$$
